(19) United States
(12) Patent Application Publication
(10) Pub. No.: US 2026/0287817 A1
(43) Pub. Date: Sep. 24, 2026

(54) OPTICAL WAVEGUIDE DEVICE, OPTICAL CONNECTION STRUCTURE, AND OPTICAL CONNECTION METHOD

(71) Applicants: SUMITOMO ELECTRIC INDUSTRIES, LTD., Osaka-shi, Osaka (JP); Sumitomo Electric Optifrontier Co., Ltd., Yokohama-shi, Kanagawa (JP)

(72) Inventors: Naoki YOKOYAMA, Kanagawa (JP); Hajime ARAO, Osaka (JP); Tetsuya NAKANISHI, Osaka (JP)

(73) Assignees: SUMITOMO ELECTRIC INDUSTRIES, LTD., Osaka-shi, Osaka (JP); Sumitomo Electric Optifrontier Co., Ltd., Yokohama-shi, Kanagawa (JP)

(21) Appl. No.: 19/474,408

(22) PCT Filed: Apr. 24, 2024
(86) PCT No.: PCT/JP2024/016114

§ 371 Date: Oct. 10, 2025

(30) Foreign Application Priority Data
May 22, 2023 (JP) 2023-083999

(51) Int. Cl. G02B 6/125; G02B 6/40

(52) U.S. Cl. CPC G02B 6/125; G02B 6/403

(57) ABSTRACT

An optical waveguide device includes a cladding having a first surface and a second surface different from the first surface, at least one first core extending through the cladding from the first surface to the second surface, and a second core formed in a region of the cladding excluding the first core and extending from the first surface through the inside of the cladding to return to the first surface.

### TECHNICAL FIELD

The present disclosure relates to an optical waveguide device, an optical connection structure, and an optical connection method.

Priority is claimed on Japanese Patent Application No. 2023-083999 filed on May 22, 2023, the entire content of which is incorporated herein by reference.

### BACKGROUND ART

For example, Patent Literature 1 discloses an optical waveguide device including a cladding and a plurality of cores surrounded by the cladding. In this optical waveguide device, the pitch between the cores inside the cladding is transformed along a propagation direction of light. Such an optical waveguide device is disposed, for example, between two fiber arrays having different core pitches from each other, and enables these fiber arrays to be optically connected with low loss.

### CITATION LIST

### Patent Literature

[Patent Literature 1] PCT International Publication No. WO 2018/135411

### SUMMARY OF INVENTION

An optical waveguide device according to one embodiment of the present disclosure includes a cladding having a first surface and a second surface different from the first surface, at least one first core extending through the cladding from the first surface to the second surface, and a second core formed in a region of the cladding excluding the first core and extending from the first surface through the inside of the cladding to return to the first surface.

### BRIEF DESCRIPTION OF DRAWINGS

FIG. 1 is a perspective view illustrating an optical connection structure according to a first embodiment.

FIG. 2 is a perspective view illustrating an optical waveguide device of FIG. 1.

FIG. 3 is a side view illustrating the optical waveguide device of FIG. 2.

FIG. 4a is a front view illustrating the optical waveguide device of FIG. 2.

FIG. 4b is a front view of a first optical fiber array facing the optical waveguide device of FIG. 4a.

FIG. 5a is a rear view illustrating the optical waveguide device of FIG. 2.

FIG. 5b is a front view of a second optical fiber array facing the optical waveguide device of FIG. 5a.

FIG. 6 is a flowchart showing steps of an optical connection method according to the first embodiment.

FIG. 7a is a plan view showing a state in which the optical waveguide device and the first optical fiber array are actively aligned.

FIG. 7b is a plan view illustrating a state in which the optical waveguide device and the second optical fiber array are actively aligned.

FIG. 8 is a perspective view illustrating an optical connection structure according to a second embodiment.

FIG. 9 is a perspective view illustrating the optical waveguide device of FIG. 8.

FIG. 10 is a side view illustrating the optical waveguide device of FIG. 9.

FIG. 11a is a front view illustrating the optical waveguide device of FIG. 9.

FIG. 11b is a front view illustrating a first optical fiber array facing the optical waveguide device of FIG. 11a.

FIG. 12a is a rear view illustrating the optical waveguide device of FIG. 9.

FIG. 12b is a front view illustrating a second optical fiber array facing the optical waveguide device of FIG. 12a.

### DESCRIPTION OF EMBODIMENTS

### Problems to be Solved by Present Disclosure

In order to optically connect three members of the optical waveguide device and the two fiber arrays described above, an alignment operation is performed to adjust relative positions of these three members so that optical axes of cores of the three members coincide with each other. Examples of such alignment methods include, for example, an active alignment in which test light is actually introduced into the three members and disposition of the three members is adjusted while monitoring an optical coupling loss between the three members, and a passive alignment in which disposition of the three members is adjusted while observing markers or the like formed on the three members or their peripheral components as references. In passive alignment, due to errors in positions of references such as markers, or errors in detection position of the cores during observation, it may become difficult to achieve a high-accuracy alignment of the three members. On the other hand, in active alignment in which disposition of the three members is adjusted while monitoring test light, it is possible to achieve a higher-accuracy alignment of the three members compared to a passive alignment.

In the active alignment, for example, test light is incident from a first fiber array, and the intensity of the test light emitted from a second fiber array via the optical waveguide device is measured by a photodetector such as a power meter. Then, a three-body alignment in which dispositions of the three members are relatively adjusted is performed so that the intensity of the test light is maximized. Here, in the active alignment premised on monitoring the test light, it is required that dispositions of the three members be adjusted with a certain degree of accuracy so that the test light passes through the cores of the three members. However, since it is not easy to find dispositions of the three members through which the test light passes while moving the three members relative to one another as described above, there is a likelihood that alignment work until the optical axes of the cores of the three members are aligned may take more time than necessary. Therefore, it is desirable to perform the alignment of the three members more easily.

The present disclosure provides an optical waveguide device, an optical connection structure, and an optical connection method that facilitate alignment of the three members more easily.

### Advantageous Effects of the Present Disclosure

According to the optical waveguide device, the optical connection structure, and the optical connection method according to the present disclosure, alignment of the three members can be performed more easily.

### Description of Embodiments of Present Disclosure

First, content of embodiments of the present disclosure will be listed and described.
(1) An optical waveguide device according to one embodiment of the present disclosure includes a cladding having a first surface and a second surface different from the first surface, at least one first core extending through the cladding from the first surface to the second surface, and a second core formed in a region of the cladding excluding the first core and extending from the first surface through the inside of the cladding to return to the first surface.

The above-described optical waveguide device is used, for example, to optically connect two optical fiber arrays together. In this case, the first surface of the optical waveguide device faces one of the optical fiber arrays (hereinafter referred to as a “first optical fiber array”). The second surface of the optical waveguide device faces the other of the optical fiber arrays (hereinafter referred to as a “second optical fiber array”). The first core of the optical waveguide device is optically connected to the first optical fiber array at the first surface and optically connected to the second optical fiber array at the second surface. Therefore, the first core can be used as a communication core for transmitting communication light necessary for communication between these optical fiber arrays. The optical waveguide device described above includes, in addition to the first core, the second core that extends from the first surface through the inside of the cladding and returns to the first surface. The second core can be used as an alignment core for actively aligning the two members, the optical waveguide device and the first optical fiber array. The test light for actively aligning the two members is emitted from the first optical fiber array to the first surface, passes through the second core, and returns to the first optical fiber array from the first surface. Thus, if the test light that has returned to the first optical fiber array is measured with a power meter or the like, a two-body alignment can be performed in which dispositions of the two members, namely the optical waveguide device and the first optical fiber array, are adjusted so that the intensity of the test light is maximized.

After the two-body alignment between the first optical fiber array and the optical waveguide device is performed in this manner, the remaining second optical fiber array is then aligned in a two-body alignment with respect to the already aligned optical waveguide device. As a result, the three members, namely the first optical fiber array, the optical waveguide device, and the second optical fiber array, are aligned by active alignment. In this way, when the above-described optical waveguide device is used, the three-body alignment of adjusting dispositions of the three members relative to each other is not performed at once, instead, the two-body alignment of adjusting dispositions of the two members relative to each other is performed in two separate steps. In this case, compared to a case in which the three-body alignment is performed at once, dispositions of the three members through which the test light passes can be found more easily, thereby reducing the difficulty in adjusting positions of the three members when actively aligning the three members. Further, when the active alignment is used in this way, since the three members can be more reliably aligned while referencing optical axis positions of the three members, a time required for aligning the three members can be reduced compared to a case in which only a passive alignment is performed. Therefore, according to the optical waveguide device described above, the alignment of the three members can be performed more easily.
(2) In the optical waveguide device described in (1) above, the first core may include a core end face exposed on the first surface. The second core may include a first core end face and a second core end face exposed on the first surface at positions different from the position of the core end face. In this case, a configuration in which the test light emitted from the first optical fiber array to the first surface passes through the second core and returns to the first optical fiber array can be suitably achieved.
(3) In the optical waveguide device described in (2) above, the first core end face and the second core end face may be disposed in alignment with the core end face in one direction along the first surface. In this case, since the second core can be formed on the same plane as the first core, an operation of forming the second core inside the cladding is facilitated.
(4) In the optical waveguide device described in (3) above, the first core end face and the second core end face may be disposed to be aligned on one side of the core end face in the one direction. In this case, the second core that extends inside the cladding without intersecting the first core can be easily formed. By avoiding the intersection between the first core and the second core in this way, it is possible to avoid interference and loss of optical signals passing through the first core and the second core.
(5) In the optical waveguide device described in (4) above, the second core may extend inside the cladding along a plane intersecting the first surface and passing through the first core end face and the second core end face. In this case, since the second core is formed on a single plane, an operation of forming the second core inside the cladding is facilitated.
(6) In the optical waveguide device described in (3) above, the first core end face and the second core end face may be respectively disposed on opposite sides of the core end face in the one direction. In this case, the distance between the first core end face and the second core end face can be made larger than when they are adjacent to each other, and thus a large distance can be maintained between them. As a result, when the first optical fiber array is actively aligned with the optical waveguide device using the test light for alignment, it is possible to reduce a risk of rotational misalignment between a position of the first core end face where the test light is incident or emitted and a position of the second core end face where the test light is emitted or incident. Thereby, it is possible to more reliably align the optical waveguide device and the first optical fiber array. Further, if the distance between the first core end face and the second core end face can be maintained large in this way, larger a radius of curvature of the curved portion that can be formed in the path of the second core from the first core end face to the second core end face can be maintained compared to a case in which the first core end face and the second core end face are aligned adjacent to each other. Thereby, it is possible to reduce a propagation loss of the test light introduced into the second core during alignment.
(7) In the optical waveguide device described in (6) above, the second core may include a first portion extending along a plane intersecting the first surface and passing through the first core end face and the second core end face, and a second portion formed in a region spaced from the plane and extending so as to intersect the first core when viewed in the normal direction of the plane. In this case, the path of the second core can be three-dimensionally varied so that it does not intersect the first core inside the cladding. By avoiding the intersection between the first core and the second core in this way, it is possible to avoid occurrence of interference and loss of optical signals passing through the first core and the second core.
(8) The optical waveguide device described in any one of (3) to (7) above may include a plurality of first cores. The core end faces of the plurality of the first cores may include a first adjacent end face adjacent to either the first core end face or the second core end face in the one direction, and a second adjacent end face adjacent to the first adjacent end face in the one direction. A distance between the one of the first core end face and the second core end face and the first adjacent end face may be the same as a distance between the first adjacent end face and the second adjacent end face. For example, when the first optical fiber array is optically connected to the optical waveguide device, the plurality of optical fibers included in the first optical fiber array are held in a holder in a state of being aligned corresponding to the first core and the second core. A plurality of holding portions (for example, V-grooves) for holding the plurality of optical fibers are formed in the holder. Such holding portions are usually formed to be aligned at regular intervals assuming that a plurality of optical fibers are to be aligned at regular intervals. Also in the above-described configuration, the plurality of first cores and second cores can be aligned at regular intervals, and accordingly, an existing holder that holds the plurality of optical fibers aligned at regular intervals can be used. In this way, according to the above-described configuration, the existing holder can be used as it is without modification, and therefore has excellent versatility.
(9) In the optical waveguide device described in any one of (1) to (8) above, the mode field diameter of the second core on the first surface may be the same as the mode field diameter of the first core on the first surface. For example, when the first optical fiber array is optically connected to the optical waveguide device, the plurality of optical fibers included in the first optical fiber array are held in a holder in a state of being aligned corresponding to the first core and the second core. A plurality of holding portions (for example, V-grooves) for holding the plurality of optical fibers are formed in the holder. Such holding portions are usually formed in the same size and shape, assuming that general-purpose optical fibers are used. Also in the above-described configuration, the mode field diameter of the second core is set to be the same as the mode field diameter of the first core, assuming that general-purpose optical fibers are optically connected to the first core and second core. Therefore, according to the above configuration, the existing holder capable of holding the general-purpose optical fibers can be used as it is, and therefore has excellent versatility.
(10) The optical waveguide device described in (1) to (9) above may further include a third core formed in a region of the cladding excluding the first core and the second core, and extending from the second surface through the inside of the cladding to return to the second surface. In this case, the third core can be used as an alignment core for actively aligning the two members, namely the optical waveguide device and the second optical fiber array. The test light for actively aligning the two members is emitted from the second optical fiber array to the second surface, passes through the third core, and returns to the second optical fiber array from the second surface. Thus, if the test light that has returned to the second optical fiber array is measured with a power meter or the like, the two-body alignment can be performed in which dispositions of the two members, namely the optical waveguide device and the second optical fiber array, are adjusted so that the intensity of the test light is maximized. In this way, by respectively performing the two-body alignment of the first optical fiber array and the optical waveguide device, and the two-body alignment of the optical waveguide device and the second optical fiber array, it is possible to perform the alignment of the three members, namely the first optical fiber array, the optical waveguide device, and the second optical fiber array, more easily.
(11) An optical connection structure according to one embodiment of the present disclosure includes the optical waveguide device according to any one of (1) to (10) described above, and an optical fiber array disposed to face the first surface. The optical fiber array includes at least one first optical fiber optically connected to the first core at the first surface, and a pair of second optical fibers respectively optically connected to both ends of the second core at the first surface. Since this optical connection structure includes any one of the optical waveguide devices described above, the alignment of the three members can be performed more easily as described above.
(12) An optical connection method according to one embodiment of the present disclosure includes a step of preparing the optical waveguide device according to any one of (1) to (10) described above, a first optical fiber array, and a second optical fiber array; a step of performing an active alignment between the optical waveguide device and the first optical fiber array so that the first optical fiber array is optically connected to the optical waveguide device in a state in which the first optical fiber array is disposed facing the first surface of the optical waveguide device, and a step of performing, after the active alignment, an active alignment between the optical waveguide device and the second optical fiber array so that the second optical fiber array is optically connected to the optical waveguide device in a state in which the second optical fiber array is disposed facing the second surface of the optical waveguide device. In the step of performing the active alignment between the optical waveguide device and the first optical fiber array, test light for alignment is emitted from a first alignment optical fiber of the first optical fiber array toward the first surface, the test light traveling from the first surface, passing through the second core, and incident on a second alignment optical fiber of the first optical fiber array is measured, and the arrangement of the optical waveguide device and the first optical fiber array is adjusted so that the intensity of the test light is maximized.

According to the optical connection method described above, when the active alignment of the three members, namely the first optical fiber array, the optical waveguide device, and the second optical fiber array, is performed, the three-body alignment of adjusting dispositions of the three members relative to each other is not performed at once, instead, the two-body alignment of adjusting dispositions of the two members relative to each other is performed in two separate steps. In this case, compared to a case in which the three-body alignment is performed at once, dispositions of the three members through which the test light passes can be found more easily, thereby reducing the difficulty in adjusting positions of the three members when actively aligning the three members. Further, when the active alignment is used in this way, since the three members can be more reliably aligned by referencing optical axis positions of the cores of the three members, a time required for aligning the three members can be reduced compared to a case in which only a passive alignment is performed. Therefore, according to the optical connection method described above, the alignment of the three members can be performed more easily.
(13) An optical waveguide device according to one embodiment of the present disclosure is disposed between a first optical fiber array and a second optical fiber array, and optically connects the first optical fiber array and the second optical fiber array. The optical waveguide device includes a cladding having a first surface facing the first optical fiber array and a second surface facing the second optical fiber array, at least one communication core extending through the cladding from the first surface to the second surface and capable of transmitting communication light necessary for communication between the first optical fiber array and the second optical fiber array, and an alignment core formed in a region of the cladding excluding the communication core, extending from the first surface through the inside of the cladding to return to the first surface, and capable of transmitting test light for actively aligning the first optical fiber array and the optical waveguide device. According to this configuration, it is possible to perform the alignment of the three members, namely the first optical fiber array, the optical waveguide device, and the second optical fiber array, more easily as described above.

### Details of Embodiments of Present Disclosure

An optical waveguide device, an optical connection structure, and an optical connection method according to the present disclosure will be described below with reference to the drawings. The present disclosure is not limited to the following examples, but is intended to include all modifications defined in the claims and within the scope of equivalents of the claims. In the description of the drawings, the same or corresponding elements will be denoted by the same reference signs, and duplicate description thereof will be omitted as appropriate. For ease of understanding, the drawings may be partially simplified or exaggerated, and dimensional ratios and the like are not limited to those illustrated in the drawings.

### First Embodiment

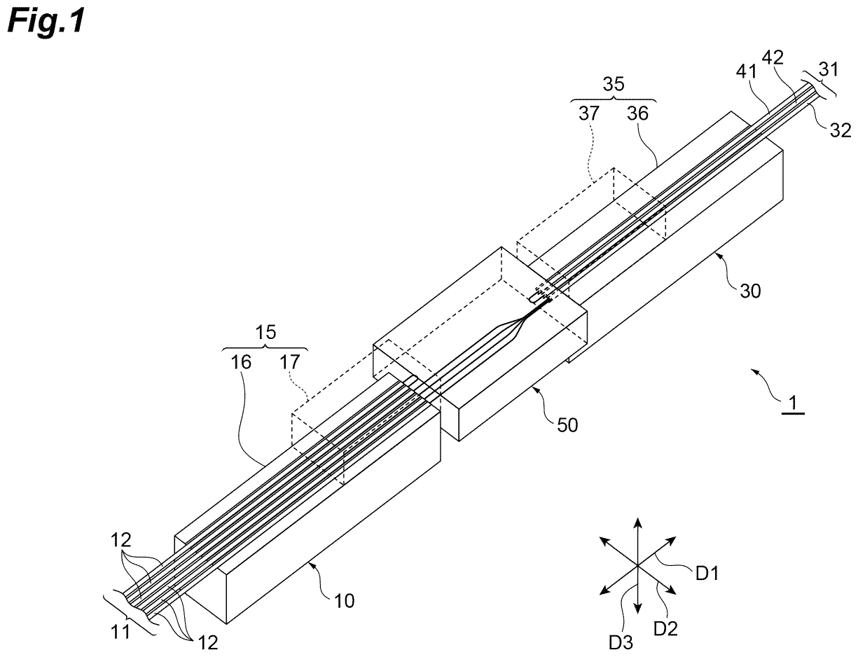

FIG. 1 is a perspective view illustrating an optical connection structure 1 according to a first embodiment. As illustrated in FIG. 1, the optical connection structure 1 includes, for example, a first optical fiber array 10, a second optical fiber array 30, and an optical waveguide device 50. In FIG. 1, for convenience, lids 17 and 37 to be described later are illustrated in broken lines.

The first optical fiber array 10, the optical waveguide device 50, and the second optical fiber array 30 are aligned in that order along a first direction D1. Thus, the optical waveguide device 50 is disposed between the first optical fiber array 10 and the second optical fiber array 30 along the first direction D1. The optical waveguide device 50 is used to optically connect the first optical fiber array 10 and the second optical fiber array 30. The optical waveguide device 50 is configured to transmit communication light (that is, an optical signal) to be transmitted between the first optical fiber array 10 and the second optical fiber array 30.

The first optical fiber array 10 includes, for example, a first optical fiber group 11 and a first holder 15 that holds the first optical fiber group 11. A distal end part of the first optical fiber group 11 extends, for example, along the first direction D1 from an MT ferrule toward the optical waveguide device 50 and faces the optical waveguide device 50 along the first direction D1. The first holder 15 is disposed at a position facing the optical waveguide device 50 along the first direction D1 and holds the distal end part of the first optical fiber group 11. The first holder 15 includes, for example, a base body 16 supporting the distal end part of the first optical fiber group 11, and the lid 17 disposed on the base body 16 to cover the distal end part of the first optical fiber group 11.

The first optical fiber group 11 includes, for example, a plurality of general-purpose single core fibers (hereinafter referred to as “SCFs”) 12. The SCFs 12 each include, for example, a single core extending along a central axis thereof and a cladding surrounding the single core. The SCFs 12 extend along the first direction D1 and are aligned in a row along a second direction D2 (an example of “one direction”) that intersects the first direction D1. The SCFs 12 are aligned, for example, at regular intervals along the second direction D2.

The second optical fiber array 30 is disposed on a side opposite to the first optical fiber array 10 with the optical waveguide device 50 interposed therebetween along the first direction D1. The second optical fiber array 30 includes, for example, a second optical fiber group 31 and a second holder 35 that holds the second optical fiber group 31. A distal end part of the second optical fiber group 31 extends, for example, along the first direction D1 from an MT ferrule toward the optical waveguide device 50 and faces the optical waveguide device 50 along the first direction D1. The second holder 35 is disposed at a position facing the optical waveguide device 50 along the first direction D1 and holds the distal end part of the second optical fiber group 31. The second holder 35 includes, for example, a base body 36 supporting the distal end part of the second optical fiber group 31 and a lid 37 disposed on the base body 36 to cover the distal end part of the second optical fiber group 31.

The second optical fiber group 31 includes, for example, a general-purpose multicore fiber (hereinafter referred to as an “MCF”) 32 and a pair of general-purpose SCFs 41 and 42. The MCF 32 includes, for example, a plurality of cores disposed at positions other than a central axis thereof, and a cladding surrounding the plurality of cores. The MCF 32 extends along the first direction D1. The cores of the MCF 32 are aligned at regular intervals in a plane defined by the second direction D2 and a third direction D3. The third direction D3 may be a direction that intersects both the first direction D1 and the second direction D2. The SCFs 41 and 42 extend along the first direction D1 and are aligned with the MCF 32 along the second direction D2.

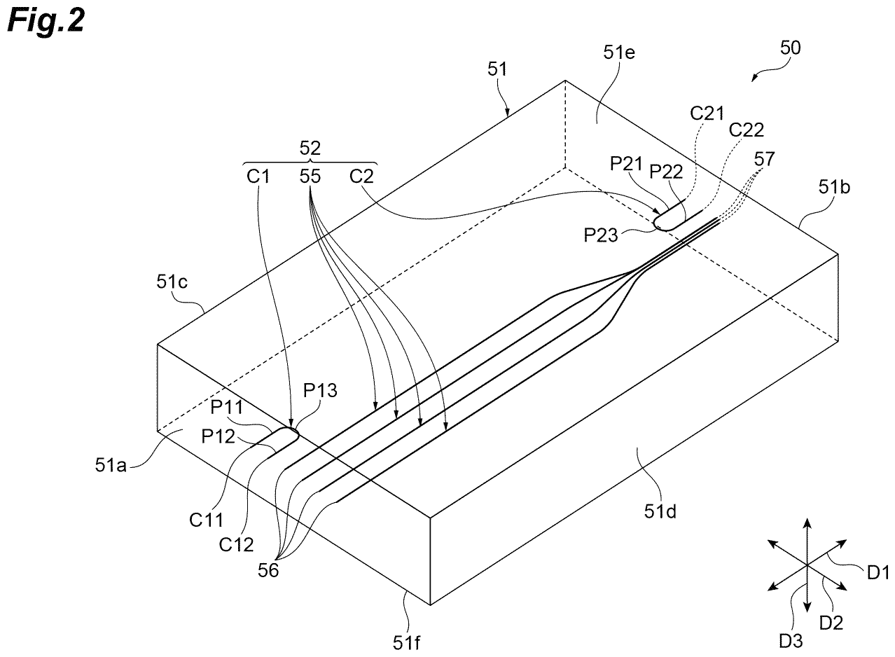

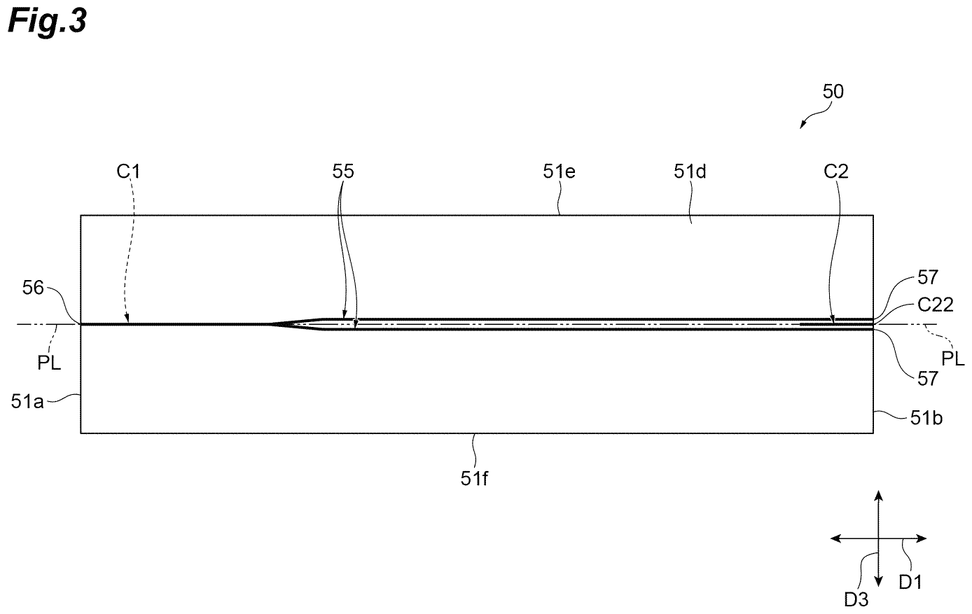

FIG. 2 is a perspective view illustrating the optical waveguide device 50. FIG. 3 is a side view illustrating the optical waveguide device 50. As illustrated in FIGS. 2 and 3, the optical waveguide device 50 includes a cladding 51 and a core group 52 formed inside the cladding 51. In each figure, for convenience, the core group 52 is indicated by a solid line.

The cladding 51 has a refractive index smaller than a refractive index of the core group 52 and surrounds the core group 52. The cladding 51 has, for example, a rectangular plate-like appearance. The cladding 51 has, for example, a first end surface 51a (an example of a “first surface”) facing the first optical fiber array 10 (see FIG. 1) along the first direction D1 and a second end surface 51b (an example of a “second surface”) facing the second optical fiber array 30 (see FIG. 1) along the first direction D1. The first and second end surfaces 51a and 51b extend along a plane intersecting the first direction D1 and are disposed to be aligned along the first direction D1.

The cladding 51 further has a first side surface 51c, a second side surface 51d, a third side surface 51e, and a fourth side surface 51f which extend along the first direction D1 between the first end surface 51a and the second end surface 51b. The first side surface 51c and the second side surface 51d extend along a plane intersecting the second direction D2 and are disposed to be aligned along the second direction D2. The third side surface 51e and the fourth side surface 51f extend along a plane intersecting the third direction D3 and are disposed to be aligned along the third direction D3.

The core group 52 includes a plurality of communication cores 55 (an example of a “first core”) for transmitting communication light between the first optical fiber array 10 and the second optical fiber array 30. The plurality of communication cores 55 extend inside the cladding 51 from the first end surface 51a to the second end surface 51b along the first direction D1 and are disposed to be aligned along the second direction D2. Each of the communication cores 55 extends along the first direction D1 and is bent in the second direction D2 and third direction D3. As a result, the communication cores 55 are converted, for example, from being aligned in a row along the second direction at the first end surface 51a to being aligned in both the second direction D2 and the third direction D3 at the second end surface 51b. In this way, the communication cores 55 constitute a three-dimensional optical waveguide that extends to vary three-dimensionally along the first direction D1, the second direction D2, and the third direction D3 inside the cladding 51.

The communication cores 55 are each formed inside the cladding 51, for example, using laser processing with pulsed laser. The pulsed laser may be, for example, a titanium sapphire femtosecond laser. When a focal point of a light pulse output from the pulsed laser is formed inside the cladding 51, a refractive index of the cladding 51 changes at the focal point. When the focal point moves along the first direction D1, second direction D2, and third direction D3, the plurality of communication cores 55 that vary three-dimensionally are formed inside the cladding 51.

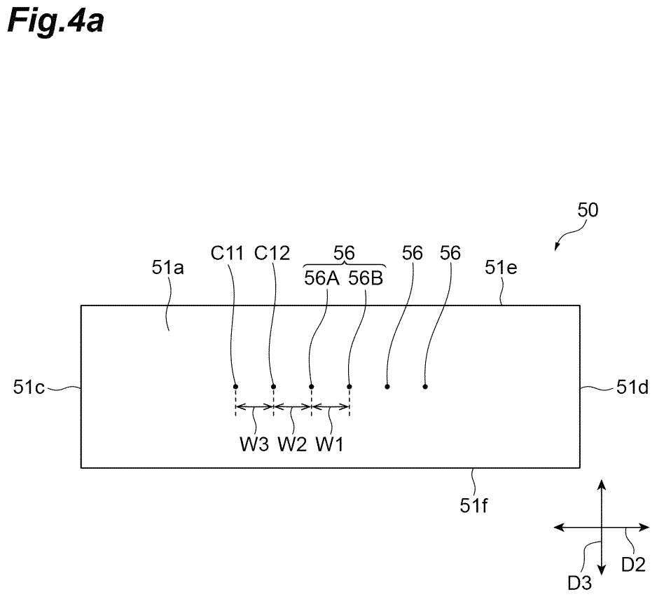

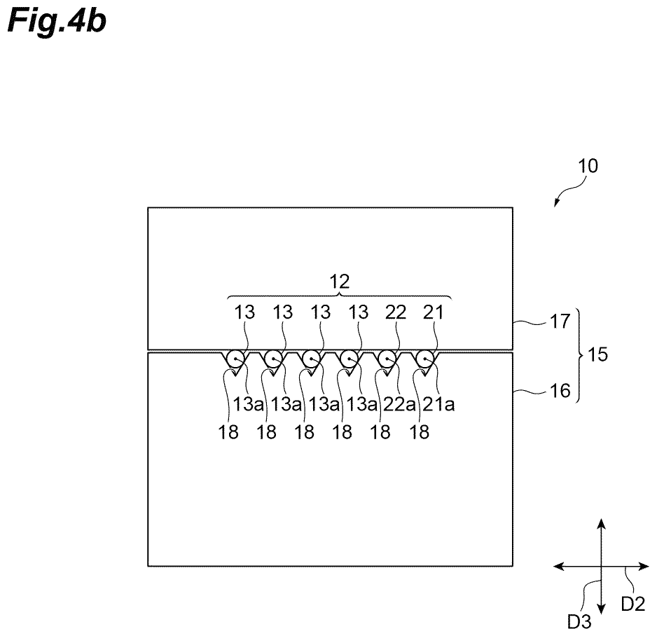

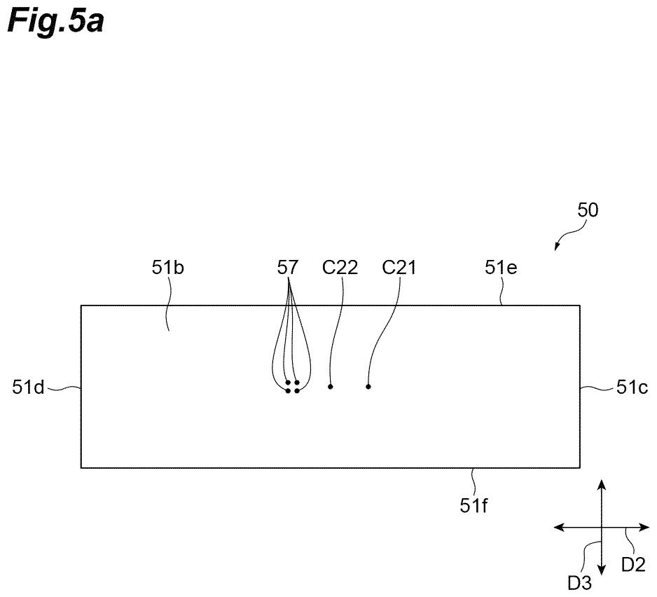

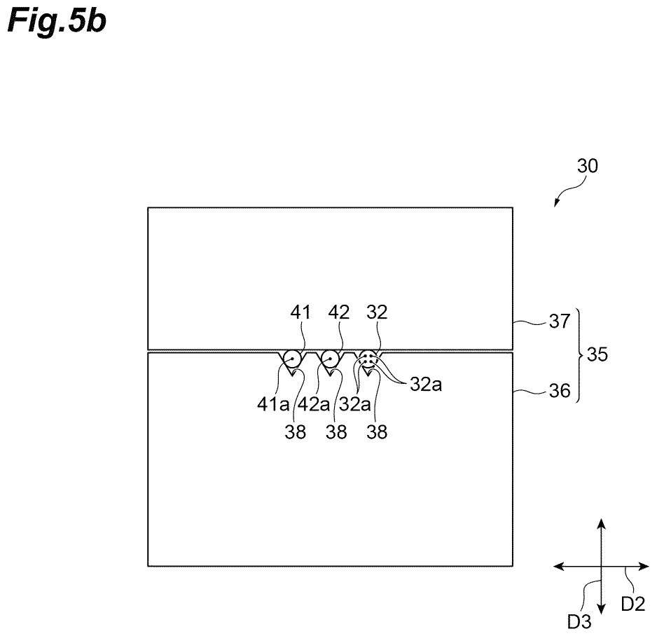

FIG. 4a is a front view of the optical waveguide device 50. FIG. 4b is a front view of the first optical fiber array 10. FIG. 5a is a rear view of the optical waveguide device 50. FIG. 5b is a front view of the second optical fiber array 30. As illustrated in FIG. 4a, core end faces 56 of the plurality of communication cores 55 are exposed at the first end surface 51a. The core end faces 56 are aligned in a row along the second direction D2 at the first end surface 51a to correspond to an alignment of the SCFs 12 (see FIG. 4b) of the first optical fiber array 10. As an example, four core end faces 56 are aligned at regular intervals along the second direction D2.

As illustrated in FIG. 5a, end faces 57 of the plurality of communication cores 55 are exposed at the second end surface 51b. The end faces 57 of the communication cores 55 are two-dimensionally aligned along the second direction D2 and third direction D3 at the second end surface 51b to correspond to an alignment of cores 32a (see FIG. 5b) of the MCF 32 of the second optical fiber array 30. As an example, four end faces 57 are aligned at regular intervals along the second direction D2 and third direction D3.

FIG. 2 is referred to again. In the present embodiment, as illustrated in FIG. 2, the core group 52 further includes, in addition to the plurality of communication cores 55 described above, a first alignment core C1 (an example of a “second core”) that transmits test light for alignment to actively align the first optical fiber array 10 and the optical waveguide device 50 and a second alignment core C2 (an example of a “third core”) that transmits test light for alignment to actively align the optical waveguide device 50 and the second optical fiber array 30. Similarly to the respective communication cores 55, the first alignment core C1 and the second alignment core C2 are formed, for example, inside the cladding 51 using laser processing with pulsed laser. The test light used for the active alignment need only be an optical signal suitable for monitoring, and may be an optical signal having a different input/output direction or wavelength from the communication light guided through the communication cores 55.

The first alignment core C1 and the second alignment core C2 are formed in a region of the cladding 51 excluding the plurality of communication cores 55, that is, in a region not overlapping the plurality of communication cores 55. The first alignment core C1 extends from the first end surface 51a through the inside of the cladding 51 and returns to the first end surface 51a. The second alignment core C2 extends from the second end surface 51b through the inside of the cladding 51 and returns to the second end surface 51b in a region of the cladding 51 excluding the plurality of communication cores 55 and the first alignment core C1, that is, a region that does not overlap the plurality of communication cores 55 and the first alignment core C1.

A configuration of the first alignment core C1 will be described in detail. As illustrated in FIG. 2, both a first core end face C11 (an example of a “first core end face”) and a second core end face C12 (an example of a “second core end face”) of the first alignment core C1 are exposed at the first end surface 51a. The first alignment core C1 is bent to extend from the core end face C11 through the inside of the cladding 51 to the core end face C12. When viewed along the third direction D3, the first alignment core C1 is, for example, U-shaped with an open end at the first end surface 51a. The first alignment core C1 includes, for example, a pair of straight portions P11 and P12 respectively extending along the first direction D1 from the core end faces C11 and C12, and a curved portion P13 that connects distal ends of the straight portions P11 and P12 and is curved inside the cladding 51.

The straight portions P11 and P12 and the curved portion P13 are formed at the same height inside the cladding 51 when viewed with the third direction D3 as a height direction. In other words, the straight portions P11 and P12 and the curved portion P13 extend along the same plane PL (see FIG. 3) along the first direction D1 and the second direction D2 inside the cladding 51. The plane PL may be, for example, a virtual plane perpendicular to the first end surface 51a and passing through an optical axis of the first alignment core C1 at each of the core end faces C11 and C12. A normal direction of the plane PL may be, for example, a direction along the third direction D3. In this way, the first alignment core C1 constitutes a two-dimensional waveguide that is not bent in the third direction D3, but is bent in the plane PL along the first direction D1 and the second direction D2.

As illustrated in FIG. 4a, the core end faces C11 and C12 are aligned in a row along the second direction D2 with the core end faces 56 of the plurality of communication cores 55. In the present embodiment, the core end faces C11 and C12 are disposed in one of regions on both sides of the core end faces 56 of the plurality of communication cores 55 interposed therebetween in the second direction D2. The core end face C12 is disposed, for example, at a position adjacent to a core end face 56A (an example of a “first adjacent end face”) that is positioned outermost among the plurality of core end faces 56 in the second direction D2. The core end face C11 is disposed, for example, on a side opposite to the core end face 56A with the core end face C12 interposed therebetween in the second direction D2 and is aligned adjacent to the core end face C12. The mode field diameter of the first alignment core C1 at each of the core end faces C11 and C12 may, for example, be the same as the mode field diameter of the communication core 55 at each core end face 56. The mode field diameter is a value defined on the basis of an optical intensity and is an index indicating a core diameter.

As described above, the plurality of core end faces 56 are aligned at regular intervals along the second direction D2. Similarly, the core end faces C11 and C12 are aligned at the same interval as the alignment interval of the plurality of core end faces 56. Therefore, if an interval between the core end face 56A and a core end face 56B (an example of a “second adjacent end face”) adjacent to the core end face 56A among the plurality of core end faces 56 is W1, an interval between the core end face C12 and the core end face 56A is W2, and an interval between the core end face C11 and the core end face C12 is W3, each of the intervals W2 and W3 is equal to the interval W1. As described above, the core end faces 56, the core end face C11, and the core end face C12 are aligned at regular intervals along the second direction D2.

The interval W1 between the core end face 56A and the core end face 56B may be, for example, a distance between an optical axis (that is, a central axis) of the communication core 55 at the core end face 56A and an optical axis (that is, a central axis) of the communication core 55 at the core end face 56B. The interval W2 between the core end face C12 and the core end face 56A may be, for example, a distance between an optical axis (that is, a central axis) of the first alignment core C1 at the core end face C12 and the optical axis (that is, the central axis) of the communication core 55 at the core end face 56A. The interval W3 between the core end face C11 and the core end face C12 may be, for example, a distance between an optical axis (that is, a central axis) of the first alignment core C1 at the core end face C11 and the optical axis (that is, the central axis) of the first alignment core C1 at the core end face C12.

As illustrated in FIG. 4b, the plurality of SCFs 12 in the first optical fiber array 10 includes a pair of alignment SCFs 21 and 22 (an example of a “second optical fiber”) for transmitting test light for alignment, in addition to a plurality of communication SCFs 13 (an example of a “first optical fiber”) for transmitting communication light. The plurality of communication SCFs 13 extend along the first direction D1 and are aligned in a row along the second direction D2. The alignment SCFs 21 and 22 extend along the first direction D1 and are aligned in a row with the plurality of communication SCFs 13 along the second direction D2. The alignment SCFs 21 and 22 are disposed, for example, in one of regions on both sides of the plurality of communication SCFs 13 interposed therebetween along the second direction D2. The plurality of communication SCFs 13 and the alignment SCFs 21 and 22 are aligned, for example, in a row at regular intervals along the second direction D2.

The plurality of communication SCFs 13 and the alignment SCFs 21 and 22 are respectively placed on a plurality of V-grooves 18 formed on the base body 16 of the first holder 15. The plurality of V-grooves 18 extend along the first direction D1 and are aligned at regular intervals along the second direction D2, corresponding to the arrangement of the communication SCFs 13 and the SCFs 21 and 22. The communication SCFs 13 are respectively disposed at the first end surface 51a to face the core end faces 56 (see FIG. 4a) of the communication cores 55. Cores 13a of the communication SCFs 13 are respectively optically connected to the communication cores 55 at the first end surface 51a. The alignment SCFs 21 and 22 are respectively disposed at the first end surface 51a to face the core end faces C11 and C12 (see FIG. 4a) of the first alignment core C1. Each of cores 21a and 22a of the alignment SCFs 21 and 22 is optically connected to the first alignment core C1 at the first end surface 51a.

The alignment SCFs 21 and 22 and the first alignment core C1 are used for actively aligning the first optical fiber array 10 and the optical waveguide device 50. The alignment SCFs 21 and 22 and the first alignment core C1 constitute an optical waveguide for transmitting test light for active alignment. For example, when test light is emitted from the alignment SCF 21, the test light enters the first alignment core C1 from the core end face C11, is emitted from the core end face C12, and enters the alignment SCF 22. In this manner, the first alignment core C1 has a loopback structure that returns the test light emitted from the first optical fiber array 10 back to the same first optical fiber array 10. The first optical fiber array 10 and the optical waveguide device 50 can be actively aligned by adjusting the dispositions of the first optical fiber array 10 and the optical waveguide device 50 so that the intensity of the test light that has returned to the first optical fiber array 10 is maximized while monitoring the intensity.

Next, a configuration of the second alignment core C2 will be described in detail. As illustrated in FIG. 2, both ends of the second alignment core C2, that is, a first core end face C21 and a second core end face C22, are exposed at the second end surface 51b. The second alignment core C2 is bent to extend from the core end face C21 through the inside of the cladding 51 to the core end face C22. When viewed along the third direction D3, the second alignment core C2 is, for example, U-shaped with an open end at the second end surface 51b. The second alignment core C2 includes, for example, a pair of straight portions P21 and P22 respectively extending along the first direction D1 from the core end faces C21 and C22, and a curved portion P23 that connects distal ends of the straight portions P21 and P22 and is curved inside the cladding 51. The straight portions P21 and P22 and the curved portion P23 extend along the same plane PL (see FIG. 3) as in the first alignment core C1. Therefore, similarly to the first alignment core C1, the second alignment core C2 constitutes a two-dimensional waveguide that is not bent in the third direction D3, but is bent in the plane PL along the first direction D1 and the second direction D2.

As illustrated in FIG. 5a, the core end faces C21 and C22 are disposed in one of regions on both sides of the end faces 57 of the plurality of communication cores 55 interposed therebetween in the second direction D2. For example, the core end face C22 is disposed at a position adjacent to the end faces 57 of the plurality of communication cores 55 along the second direction D2, and the core end face C21 is disposed on a side opposite to the end faces 57 of the plurality of communication cores 55 with the core end face C22 interposed therebetween in the second direction D2. The mode field diameter of the second alignment core C2 at each of the core end faces C21 and C22 may, for example, be the same as the mode field diameter of the communication core 55 at each end face 57.

As illustrated in FIG. 5b, the second optical fiber array 30 includes a pair of alignment SCFs 41 and 42 (hereinafter referred to as “alignment SCFs 41 and 42”) for transmitting test light for alignment, in addition to the communication MCF 32 for transmitting communication light. The MCF 32 and the alignment SCFs 41 and 42 are aligned, for example, in a row at regular intervals along the second direction D2. The alignment SCFs 41 and 42 are disposed, for example, in one of regions on both sides of the MCF 32 interposed therebetween in the second direction D2.

The MCF 32 and the alignment SCFs 41 and 42 are respectively placed on a plurality of V-grooves 38 formed in the base body 36 of the second holder 35. The plurality of V-grooves 38 extend along the first direction D1 and are aligned at regular intervals along the second direction D2, corresponding to the arrangement of the MCF 32 and the SCFs 41 and 42. The MCF 32 is disposed to face the end face 57 (see FIG. 5a) of each communication core 55 at the second end surface 51b. Each core 32a of the MCF 32 is optically connected to each communication core 55 at the second end surface 51b. The alignment SCFs 41 and 42 are respectively disposed at the second end surface 51b to face the core end faces C21 and C22 (see FIG. 5a) of the second alignment core C2. Each of cores 41a and 42a of the alignment SCFs 41 and 42 is optically connected to the second alignment core C2 at the second end surface 51b.

The alignment SCFs 41 and 42 and second alignment core C2 are used for actively aligning the second optical fiber array 30 and the optical waveguide device 50. The alignment SCFs 41 and 42 and the second alignment core C2 constitute an optical waveguide for transmitting test light for active alignment. For example, when test light is emitted from the alignment SCF 41, the test light enters the second alignment core C2 from the core end face C21, is emitted from the core end face C22, and enters the alignment SCF 42. In this manner, the second alignment core C2 has a loopback structure that returns the test light emitted from the second optical fiber array 30 back to the same second optical fiber array 30. Then, the second optical fiber array 30 and the optical waveguide device 50 can be actively aligned by adjusting the disposition of the second optical fiber array 30 and the optical waveguide device 50 so that the intensity of the test light that has returned to the second optical fiber array 30 is maximized while monitoring the intensity.

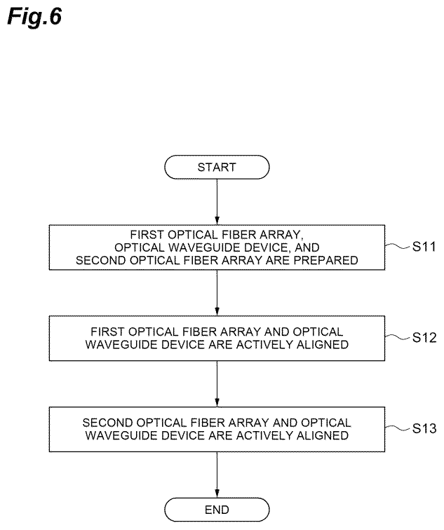

Next, an optical connection method using the optical waveguide device 50 described above will be described. FIG. 6 is a flowchart showing steps of the optical connection method according to the present embodiment.

First, the first optical fiber array 10, the optical waveguide device 50, and the second optical fiber array 30 described above are prepared (step S11). Next, the first optical fiber array 10 and the optical waveguide device 50 are actively aligned (step S12). In order for these to be actively aligned, it is desirable that a position adjustment between the first optical fiber array 10 and the optical waveguide device 50 be performed with a certain degree of accuracy. Accordingly, before the active alignment, the first optical fiber array 10 and the optical waveguide device 50 may be passively aligned. In this case, for example, identifiable grooves, markers, or the like are formed on mounting substrates of respective members, and the first optical fiber array 10 and the optical waveguide device 50 are positioned using them as references. Then, with the positions of the first optical fiber array 10 and the optical waveguide device 50 adjusted with a certain degree of accuracy in this manner, an active alignment between the first optical fiber array 10 and the optical waveguide device 50 may be performed.

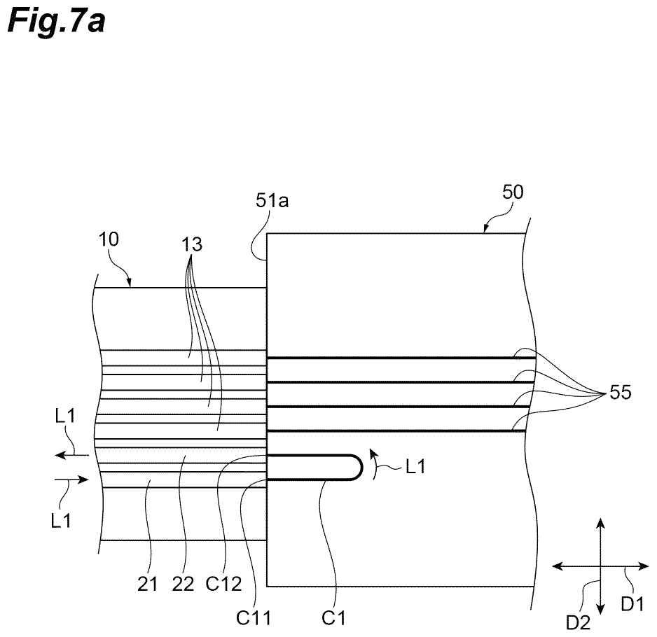

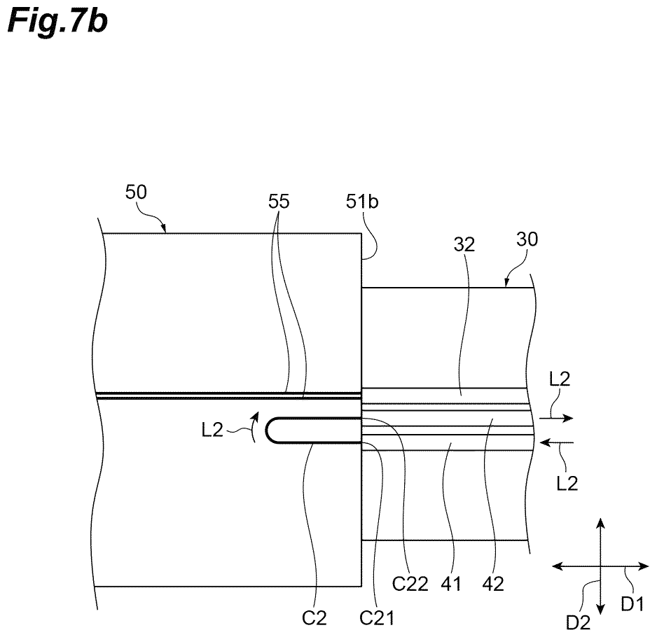

FIG. 7a is a plan view illustrating a state in which the optical waveguide device 50 and the first optical fiber array 10 are actively aligned. When the first optical fiber array 10 and the optical waveguide device 50 are actively aligned, as illustrated in FIG. 7a, with the first optical fiber array 10 disposed to face the first end surface 51a of the optical waveguide device 50, test light L1 is emitted from the alignment SCF 21 of the first optical fiber array 10 toward the core end face C11 of the first alignment core C1. The test light L1 emitted from the alignment SCF 21 passes through the first alignment core C1 and is emitted from the core end face C12 toward the alignment SCF 22 of the first optical fiber array 10. Then, the intensity of the test light L1 incident on the alignment SCF 22 is measured by a photodetector such as a power meter.

Thereafter, the first optical fiber array 10 is moved with respect to the optical waveguide device 50 in a plane along the second direction D2 and the third direction D3 so that the intensity of the test light L1 becomes maximum, that is, a transmission loss between the first optical fiber array 10 and the optical waveguide device 50 becomes minimum, while monitoring the intensity of the test light L1. Optical axes of the alignment SCFs 21 and 22 are aligned with the optical axis of the first alignment core C1 by performing a two-body alignment in which relative positions between the first optical fiber array 10 and the optical waveguide device 50 are adjusted as described above. Thereby, the two members, namely the first optical fiber array 10 and the optical waveguide device 50, are aligned.

Next, the second optical fiber array 30 and the optical waveguide device 50 are actively aligned (step S13). In order for these to be actively aligned, it is desirable that a position adjustment between the second optical fiber array 30 and the optical waveguide device 50 be performed with a certain degree of accuracy. Accordingly, before the active alignment, the second optical fiber array 30 and the optical waveguide device 50 may be passively aligned. In this case, for example, identifiable grooves, markers, or the like are formed on mounting substrates of respective members, and the second optical fiber array 30 and the optical waveguide device 50 are positioned using them as references. Then, with the positions of the second optical fiber array 30 and the optical waveguide device 50 adjusted with a certain degree of accuracy in this manner, an active alignment between the second optical fiber array 30 and the optical waveguide device 50 may be performed.

FIG. 7b is a plan view illustrating a state in which the optical waveguide device 50 and the second optical fiber array 30 are actively aligned. When the second optical fiber array 30 and the optical waveguide device 50 are actively aligned, as illustrated in FIG. 7b, with the second optical fiber array 30 disposed to face the second end surface 51b of the optical waveguide device 50, test light L2 is emitted from the alignment SCF 41 of the second optical fiber array 30 toward the core end face C21 of the second alignment core C2. The test light L2 emitted from the alignment SCF 41 passes through the second alignment core C2 and is emitted from the core end face C22 toward the alignment SCF 42 of the second optical fiber array 30. Then, the intensity of the test light L2 incident on the alignment SCF 42 is measured by a photodetector such as a power meter.

Thereafter, the second optical fiber array 30 is moved with respect to the optical waveguide device 50 in a plane along the second direction D2 and the third direction D3 so that the intensity of the test light L2 is maximized, that is, a transmission loss between the second optical fiber array 30 and the optical waveguide device 50 is minimized, while monitoring the intensity of the test light L2. The optical axes of the alignment SCFs 41 and 42 are aligned with the optical axis of the second alignment core C2 by performing a two-body alignment in which relative positions between the second optical fiber array 30 and the optical waveguide device 50 are adjusted as described above. Thereby, the two members, namely the second optical fiber array 30 and the optical waveguide device 50, are aligned.

In this manner, when the two-body alignment in which the first optical fiber array 10 and the optical waveguide device 50 are positionally adjusted while monitoring the intensity of the test light L1, and the two-body alignment in which the second optical fiber array 30 and the optical waveguide device 50 are positionally adjusted while monitoring the intensity of the test light L2 are respectively performed, the three members, namely the first optical fiber array 10, the optical waveguide device 50, and the second optical fiber array 30, are aligned. In this state, by fixing the three members, the optical connection structure 1, in which the first optical fiber array 10, the optical waveguide device 50, and the second optical fiber array 30 are connected to each other, can be obtained. A sequence of steps of the connection method using the optical waveguide device 50 is not limited to the method in which the above-described steps S11 to S13 are sequentially performed. For example, the sequence of steps to be performed may be appropriately changed, such as step S12 being performed after step S13.

From the viewpoint of aligning the three members with higher accuracy, a conventional active alignment may be performed on the three members after the above-described active alignment (that is, after step S13). In this case, test light may be incident on the first optical fiber array 10, pass through the optical waveguide device 50, and the test light emitted from the second optical fiber array 30 may be measured. Test light may be incident on the second optical fiber array 30, pass through the optical waveguide device 50, and the test light emitted from the first optical fiber array 10 may be measured. Then, while monitoring the test light, a three-body alignment, in which the relative disposition of the three members, namely the first optical fiber array 10, the optical waveguide device 50, and the second optical fiber array 30, are adjusted relative to each other, may be performed.

Effects obtained by the optical waveguide device 50, the optical connection structure 1, and the optical connection method according to the present embodiment described above will be described.

The optical waveguide device 50 according to the present embodiment includes, in addition to the plurality of communication cores 55 for transmitting communication light, the first alignment core C1 for transmitting the test light L1 for actively aligning the two members, namely the optical waveguide device 50 and the first optical fiber array 10. The test light L1 is emitted from the first optical fiber array 10 to the first end surface 51a, passes through the first alignment core C1, and returns from the first end surface 51a back to the first optical fiber array 10. Thus, if the test light L1 that has returned to the first optical fiber array 10 is measured with a power meter, the two-body alignment in which the relative disposition of the two members, namely the optical waveguide device 50 and the first optical fiber array 10, are adjusted can be performed so that the intensity of the test light L1 is maximized. Then, similarly, by also introducing the test light L2 is also introduced into the two members, namely the optical waveguide device 50, which has been aligned with the first optical fiber array 10, and the remaining second optical fiber array 30, a two-body alignment can also be performed for these two members. As a result, the three members, namely the first optical fiber array 10, the optical waveguide device 50, and the second optical fiber array 30, are actively aligned.

In this way, when the optical waveguide device 50 is used, the three-body alignment of adjusting dispositions of the three members relative to each other is not performed at once, instead, the two-body alignment of adjusting dispositions of the two members relative to each other is performed in two separate steps. In this case, compared to a case in which the three-body alignment is performed at once, dispositions of the three members through which the test light passes can be found more easily, thereby reducing the difficulty in adjusting positions of the three members when actively aligning the three members. Further, when the active alignment is used in this way, since the three members can be more reliably aligned by referencing optical axis positions of the cores of the three members, a time required for aligning the three members can be reduced compared to a case in which only a passive alignment is performed. Therefore, according to the present embodiment, the alignment of the three members can be performed more easily.

As in the present embodiment, the core end faces C11 and C12 of the first alignment core C1 may be exposed at positions different from the core end faces 56 of the communication cores 55. In this case, a configuration in which the test light L1 emitted from the first optical fiber array 10 to the first end surface 51a passes through the first alignment core C1 and returns to the first optical fiber array 10 can be suitably achieved.

As in the present embodiment, the core end faces C11 and C12 of the first alignment core C1 may be disposed in alignment with the core end faces 56 along the second direction D2. In this case, since the first alignment core C1 can be formed on the same plane PL as the communication cores 55, the operation of forming the first alignment core C1 inside the cladding 51 is facilitated.

As in the present embodiment, the core end faces C11 and C12 of the first alignment core C1 may be disposed on one side of the core end faces 56 in the second direction D2. In this case, the first alignment core C1, which extends inside the cladding 51 without intersecting the communication cores 55, can be easily formed. By avoiding the intersection between the communication cores 55 and the first alignment core C1 in this way, occurrence of interference and loss of optical signals passing through the communication cores 55 and the first alignment core C1 can be avoided.

As in the present embodiment, the first alignment core C1 may extend inside the cladding 51 along the plane PL. In this case, the first alignment core C1 is formed on the same plane PL. Therefore, when forming the first alignment core C1 inside the cladding 51, it is not necessary to move a focal point of pulsed laser in a height direction (third direction D3) inside the cladding 51, which facilitates the work of forming the first alignment core C1.

As in the present embodiment, the interval W2 between the core end face C12 of the first alignment core C1 and the core end face 56A of the communication core 55 may be the same as the interval W1 between the core end face 56A of the communication core 55 and the core end face 56B of the communication core 55. For example, when the first optical fiber array 10 is optically connected to the optical waveguide device 50, the plurality of SCFs 12 are held by the first holder 15 in a state of being aligned corresponding to the communication cores 55 and the first alignment core C1. The plurality of V-grooves 18 for holding the plurality of SCFs 12 are formed in the first holder 15. Such V-grooves are usually formed to be aligned at regular intervals assuming that a plurality of optical fibers are to be aligned at regular intervals. Also in the above-described configuration, the plurality of communication cores 55 and the first alignment core C1 can be aligned at regular intervals, and accordingly, an existing holder (first holder 15) that holds the plurality of SCFs 12 aligned at regular intervals can be used. In this way, according to the above-described configuration, the existing holder can be used as it is without modification, and therefore has excellent versatility.

As in the present embodiment, the mode field diameter of the first alignment core C1 at the first end surface 51a may be the same as the mode field diameter of the communication core 55 at the first end surface 51a. As described above, the plurality of SCFs 12 are respectively held by the plurality of V-grooves 18 of the first holder 15. Such V-grooves are usually formed in the same size and shape, assuming that general-purpose optical fibers are used. Also in the above-described configuration, the mode field diameter of the first alignment core C1 is set to be the same as the mode field diameter of the communication cores 55, assuming that the general-purpose SCFs 12 are optically connected to the communication cores 55 and the first alignment core C1. Therefore, according to the above configuration, the existing holder (first holder 15) capable of holding the general-purpose SCFs 12 can be used as it is, and therefore has excellent versatility.

As in the present embodiment, the optical waveguide device 50 may include the second alignment core C2. In this case, the second alignment core C2 can be used as an alignment core for actively aligning the two members, namely the optical waveguide device 50 and the second optical fiber array 30. The test light L2 for actively aligning the two members is emitted from the second optical fiber array 30 to the second end surface 51b, passes through the second alignment core C2, and returns from the second end surface 51b to the second optical fiber array 30. Therefore, if the test light L2 that has returned to the second optical fiber array 30 is measured with a power meter or the like, the two-body alignment in which the relative disposition of the two members, namely the optical waveguide device 50 and the second optical fiber array 30, are adjusted can be performed so that the intensity of the test light L2 is maximized. Accordingly, in the above configuration, by respectively performing the two-body alignment of the first optical fiber array 10 and the optical waveguide device 50, and the two-body alignment of the optical waveguide device 50 and the second optical fiber array 30, the alignment of the three members, namely the first optical fiber array 10, the optical waveguide device 50, and the second optical fiber array 30, can be performed more easily.

### Second Embodiment

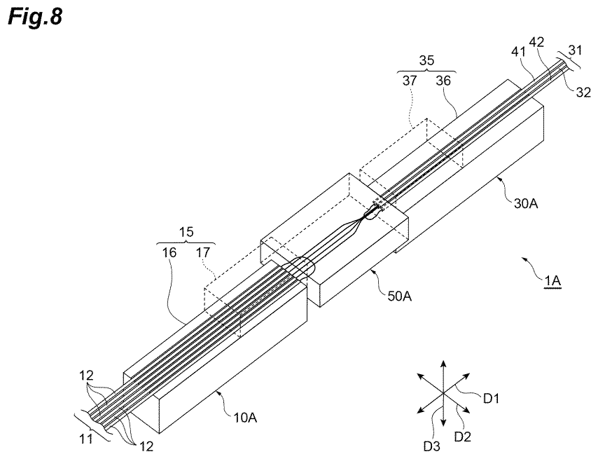

Next, an optical connection structure 1A of a second embodiment will be described. FIG. 8 is a perspective view illustrating the optical connection structure 1A. As illustrated in FIG. 8, the optical connection structure 1A includes a first optical fiber array 10A, an optical waveguide device 50A, and a second optical fiber array 30A. A main difference between the optical connection structure 1A according to the second embodiment and the optical connection structure 1 according to the first embodiment lies in a configuration of a core group formed in the optical waveguide device. Hereinafter, description will be made focusing on differences between the optical connection structure 1A and the optical connection structure 1.

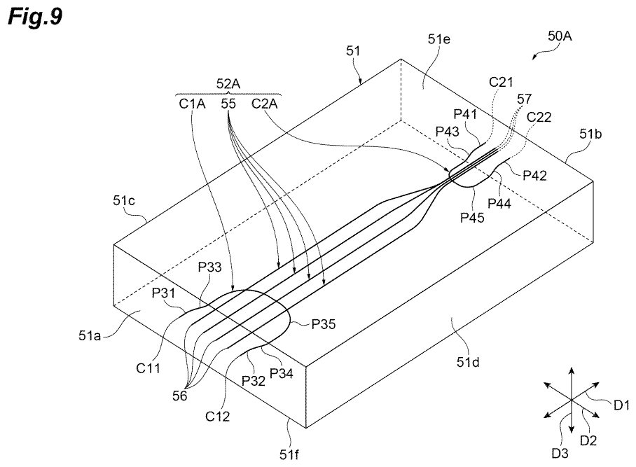

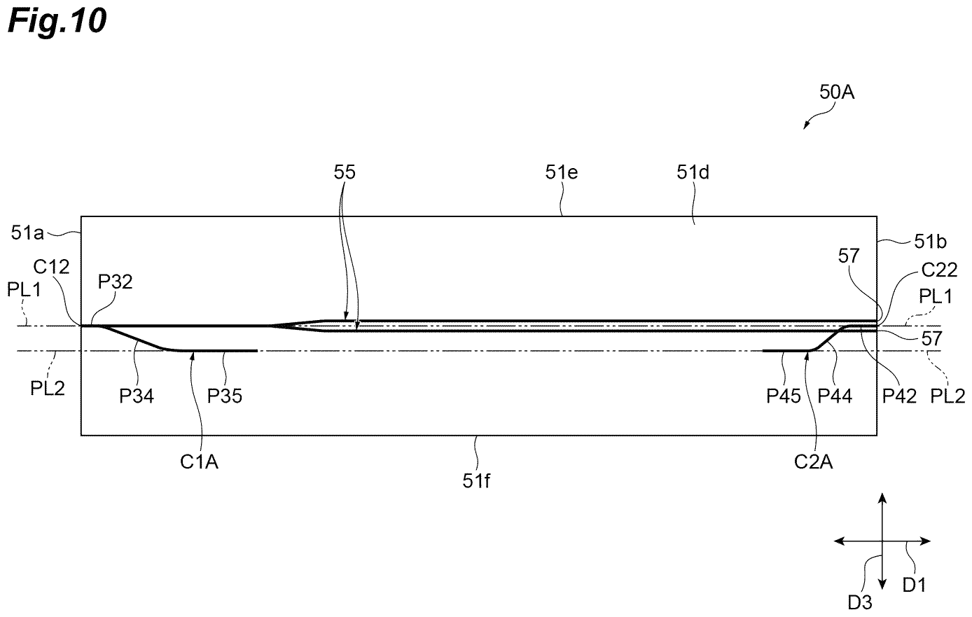

FIG. 9 is a perspective view illustrating the optical waveguide device 50A. FIG. 10 is a side view illustrating the optical waveguide device 50A. As illustrated in FIGS. 9 and 10, a core group 52A of the optical waveguide device 50A includes a first alignment core C1A and a second alignment core C2A instead of the first alignment core C1 and the second alignment core C2 of the optical waveguide device 50. The first alignment core C1A is formed inside a cladding 51 to extend across a plurality of communication cores 55 from a first end surface 51a and return to the first end surface 51a. The second alignment core C2A is formed inside the cladding 51 to extend across the plurality of communication cores 55 from a second end surface 51b and return to the second end surface 51b.

As illustrated in FIG. 9, the first alignment core C1A is, for example, U-shaped with an open end at the first end surface 51a when viewed along a third direction D3. The first alignment core C1A includes, for example, a pair of first straight portions P31 and P32 (an example of “first portions”) respectively extending in a first direction D1 from core end faces C11 and C12, a pair of second straight portions P33 and P34 (an example of “second portions”) further extending from distal ends of the pair of first straight portions P31 and P32, and a curved portion P35 (an example of the “second portion”) that connects the distal ends of the pair of second straight portions P33 and P34 and is curved inside the cladding 51.

As illustrated in FIG. 10, the first straight portions P31 and P32 extend along the same plane PL1 along the first direction D1 and a second direction D2 inside the cladding 51. On the other hand, the second straight portions P33 and P34 and the curved portion P35 extend in a region spaced from the plane PL1. The second straight portions P33 and P34 extend in a direction bent from the distal ends of the first straight portions P31 and P32 to a fourth side surface 51f side along the third direction D3. The second straight portions P33 and P34 extend in a direction inclined with respect to both the first direction D1 and the third direction D3 when viewed along the second direction D2. The plane PL1 may be, for example, a virtual plane that is perpendicular to the first end surface 51a and passes through optical axes of the first alignment core C1A at the respective core end faces C11 and C12.

The curved portion P35 extends along a plane PL2 that is displaced from the plane PL1 to the fourth side surface 51f side along the third direction D3. As illustrated in FIG. 9, the curved portion P35 extends to intersect the plurality of communication cores 55 when viewed along the third direction D3. The first alignment core C1A including the first straight portions P31 and P32, the second straight portions P33 and P34, and the curved portion P35 constitutes a three-dimensional waveguide that is bent in the first direction D1, the second direction D2, and the third direction D3.

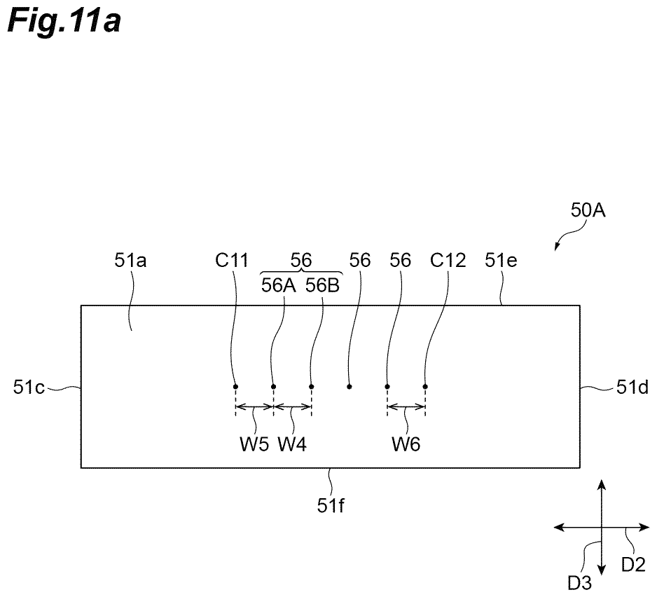

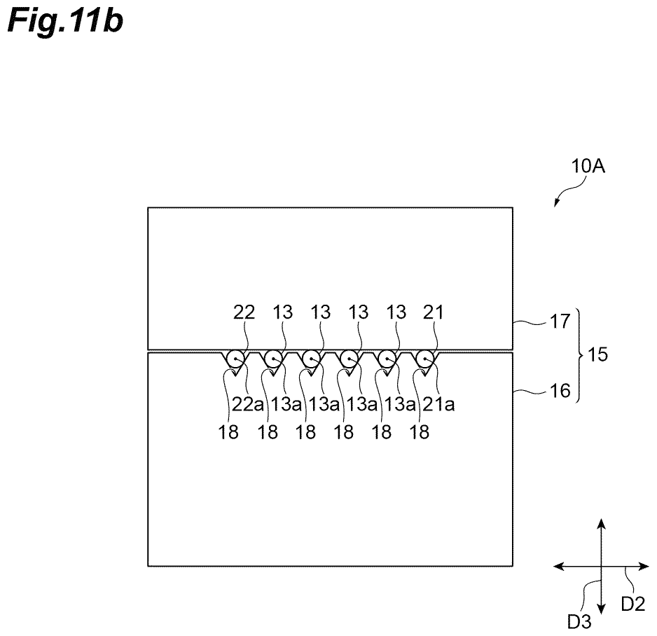

FIG. 11a is a front view illustrating the optical waveguide device 50A. FIG. 11b is a front view illustrating the first optical fiber array 10A. As illustrated in FIG. 11a, the core end faces C11 and C12 are aligned in a row with core end faces 56 of the plurality of communication cores 55 along the second direction D2. In the present embodiment, the core end faces C11 and C12 are respectively disposed in regions on both sides of the core end faces 56 of the plurality of communication cores 55 interposed therebetween in the second direction D2, respectively. The core end face C11 is disposed, for example, at a position adjacent to a core end face 56A (an example of a “first adjacent end face”) positioned outermost among the plurality of core end faces 56 in the second direction D2. The core end face C12 is disposed, for example, on a side opposite to the core end face C11 with the plurality of core end faces 56 interposed therebetween in the second direction D2. The mode field diameter of the first alignment core C1A at each of the core end faces C11 and C12 may be the same as, for example, the mode field diameter of the communication core 55 at each core end face 56.

If an interval between the core end face 56A and a core end face 56B (an example of a “second adjacent end face”) adjacent to the core end face 56A among the plurality of core end faces 56 is W4, an interval between the core end face C11 and the core end face 56A is W5, and an interval between the core end face C12 and the core end face 56 adjacent to the core end face C12 is W6, the interval W5 and the interval W6 are equal to the interval W4, respectively. As described above, the core end faces 56, the core end face C11, and the core end face C12 are aligned at regular intervals along the second direction D2.

As illustrated in FIG. 11b, alignment SCFs 21 and 22 of the first optical fiber array 10A are respectively disposed, for example, in regions on both sides of a plurality of communication SCFs 13 interposed therebetween along the second direction D2. The plurality of communication SCFs 13 and the alignment SCFs 21 and 22 are aligned, for example, in a row at regular intervals in the second direction D2. The alignment SCFs 21 and 22 are disposed to respectively face the core end faces C11 and C12 of the first alignment core C1A (see FIG. 11a) at the first end surface 51a. Each of cores 21a and 22a of the alignment SCFs 21 and 22 is optically connected to the first alignment core C1A at the first end surface 51a.

As illustrated in FIG. 9, the second alignment core C2A is, for example, U-shaped with an open end at the second end surface 51b when viewed along the third direction D3. The second alignment core C2A includes, for example, a pair of first straight portions P41 and P42 respectively extending along the first direction D1 from core end faces C21 and C22, a pair of second straight portions P43 and P44 further extending from distal ends of the pair of first straight portions P41 and P42, and a curved portion P45 that connects the distal ends of the pair of second straight portions P43 and P44 and is curved inside the cladding 51.

As illustrated in FIG. 10, the first straight portions P41 and P42 extend along the same plane PL1 inside the cladding 51. On the other hand, the second straight portions P43 and P44 and the curved portion P45 extend in a region spaced from the plane PL1. For example, the second straight portions P43 and P44 extend in a direction bent from the distal ends of the first straight portions P41 and P42 to the fourth side surface 51f side in the third direction D3. In other words, the second straight portions P43 and P44 extend in a direction inclined with respect to both the first direction D1 and the third direction D3 when viewed along the second direction D2.

The curved portion P45 extends along the plane PL2 that is displaced from the plane PL1 to the fourth side surface 51f side in the third direction D3. As illustrated in FIG. 9, the curved portion P45 extends to intersect the plurality of communication cores 55 when viewed along the third direction D3. The second alignment core C2A including the first straight portions P41 and P42, the second straight portions P43 and P44, and the curved portion P45 constitutes a three-dimensional waveguide that is bent in the first direction D1, the second direction D2, and the third direction D3.

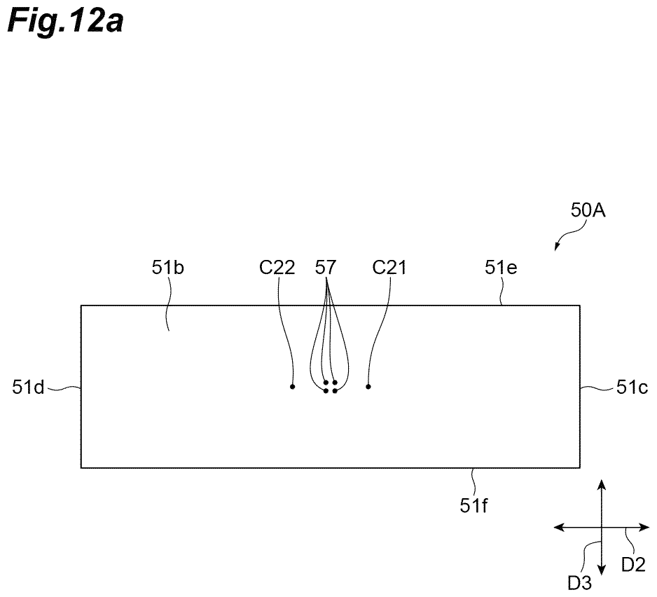

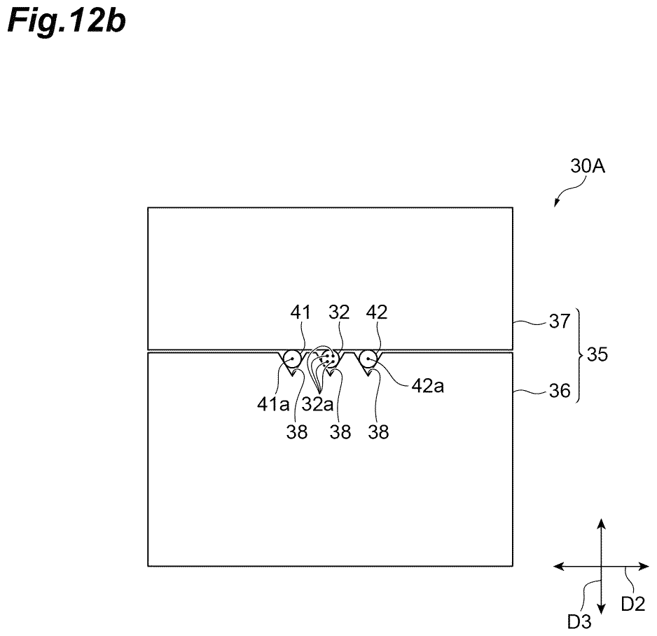

FIG. 12a is a rear view illustrating the optical waveguide device 50A. FIG. 12b is a front view illustrating the second optical fiber array 30A. As illustrated in FIG. 12a, the core end faces C21 and C22 of the second alignment core C2A are respectively disposed in regions on both sides of the end faces 57 of the plurality of communication cores 55 interposed therebetween in the second direction D2. For example, the core end face C22 is disposed at a position adjacent to the end faces 57 of the plurality of communication cores 55 along the second direction D2. The core end face C21 is disposed on a side opposite to the core end face C22 with the end faces 57 of the plurality of communication cores 55 interposed therebetween in the second direction D2. The mode field diameter of the second alignment core C2A at each of the core end faces C21 and C22 may, for example, be the same as the mode field diameter of the communication core 55 at each end face 57.

As illustrated in FIG. 12b, the alignment SCFs 41 and 42 in the second optical fiber array 30A are aligned, for example, in a row at regular intervals along the second direction D2. The alignment SCFs 41 and 42 are disposed, for example, in one of regions on both sides of an MCF 32 interposed therebetween in the second direction D2. The alignment SCFs 41 and 42 are disposed to respectively face the core end faces C21 and C22 of the second alignment core C2A (see FIG. 12a) at the second end surface 51b. Each of cores 41a and 42a of the alignment SCFs 41 and 42 is optically connected to the second alignment core C2A at the second end surface 51b.

According to the optical connection structure 1A described above, similarly to the optical connection structure 1, since the two-body alignment in which the first optical fiber array 10A and the optical waveguide device 50A are positionally adjusted while monitoring the intensity of the test light L1, and the two-body alignment in which the second optical fiber array 30A and the optical waveguide device 50A are positionally adjusted while monitoring the intensity of the test light L2 can be respectively performed, the alignment of the three members, namely the first optical fiber array 10A, the optical waveguide device 50A, and the second optical fiber array 30A, can be performed more easily.

As in the present embodiment, the core end faces C11 and C12 of the first alignment core C1A may be respectively disposed in regions on both sides of the core end faces 56 interposed therebetween in the second direction D2, respectively. In this case, the distance between the core end faces C11 and C12 can be made larger than when they are adjacent to each other, and thus a large distance can be maintained between them. As a result, when the first optical fiber array 10A is actively aligned with the optical waveguide device 50A using the test light L1 for alignment, it is possible to reduce a risk of rotational misalignment between a position of the core end face C11 where the test light L1 is incident or emitted and a position of the core end face C12 where the test light L1 is emitted or incident. Thereby, it is possible to more reliably align the optical waveguide device 50A and the first optical fiber array 10A. Further, if the distance between the core end faces C11 and C12 can be maintained large in this way, a larger radius of curvature of the curved portion P35 of the first alignment core C1A from the core end face C11 to the core end face C12 can be maintained compared to a case in which the core end faces C11 and C12 are aligned adjacent to each other. Thereby, it is possible to reduce a propagation loss of the test light L1 introduced into the first alignment core C1A during alignment.

As in the present embodiment, the curved portion P35 of the first alignment core C1A may be formed in a region spaced from the plane PL1 and extend to intersect the plurality of communication cores 55 when viewed along the third direction D3. In this case, the first alignment core C1A can be three-dimensionally varied inside the cladding 51 so that it does not intersect the plurality of communication cores 55. By avoiding the intersection between the communication cores 55 and the first alignment core C1A in this way, it is possible to avoid interference and loss of optical signals passing through the communication cores 55 and the first alignment core C1A.

Although the embodiments have been described above, the present disclosure is not limited to the embodiments described above, and various modifications can be made within a range not departing from the gist disclosed in the claims. For example, the number and disposition of cores in the optical waveguide device may be modified within a range not departing from the gist described above. For example, the two surfaces of the cladding 51 respectively facing the first optical fiber array 10 and the second optical fiber array 30 are not limited to the first end surface 51a and the second end surface 51b, but may be any two different surfaces such as, for example, the first end surface 51a and the first side surface 51c.

The mode field diameter of the first alignment core C1 at the first end surface 51a may be set larger than the mode field diameter of the communication core 55 at the first end surface 51a. In this case, the communication core 55 and the first alignment core C1 can be easily distinguished from each other by using the difference in mode field diameters. As a result, since the test light L1 for alignment can be prevented from being erroneously introduced into the communication core 55, it is possible to perform more reliable alignment between the optical waveguide device 50 and the first optical fiber array 10 using the first alignment core C1. Similarly, the mode field diameter of the second alignment core C2 at the second end surface 51b may be set larger than the mode field diameter of the communication core 55 at the second end surface 51b.

The interval between the communication core 55 and the first alignment core C1 at the first end surface 51a may be larger than the interval between the communication cores 55 adjacent to each other at the first end surface. In this case, the communication core 55 and the first alignment core C1 can be easily distinguished from each other by using the difference in the intervals. As a result, since the test light L1 for alignment can be prevented from being erroneously introduced into the communication core 55, it is possible to perform more reliable alignment between the optical waveguide device 50 and the first optical fiber array 10 using the first alignment core C1.

### REFERENCE SIGNS LIST

1, 1A Optical connection structure
10, 10A First optical fiber array
11 First optical fiber group
12 SCF
13 Communication SCF (an example of “first optical fiber”)
13a, 21a, 22a, 32a, 41a, 42a Core
15 First holder
16, 36 Base body
17, 37 Lid
18, 38 V-groove
21, 22 Alignment SCF (an example of “second optical fiber”)
30, 30A Second optical fiber array
31 Second optical fiber group
32 MCF
35 Second holder
41, 42 Alignment SCF
50, 50A Optical waveguide device
51 Cladding
51a First end surface (an example of “first surface”)
51b Second end surface (an example of “second surface”)
51c First side surface
51d Second side surface
51e Third side surface
51f Fourth side surface
52, 52A Core group
55 Communication core (an example of “first core”)
56 Core end face
56A Core end face (an example of “first adjacent end face”)
56B Core end face (an example of “second adjacent end surface”)
57 End face
C1, C1A First alignment core (an example of “second core”)
C2, C2A Second alignment core (an example of “third core”)
C11 Core end face (an example of “first core end face”)
C12 Core end face (an example of “second core end face”)
D1 First direction
D2 Second direction (an example of “one direction”)
D3 Third direction
P11, P12, P21, P22 Straight portion
P31, P32, P41, P42 First straight portion (an example of “first portion”)
P33, P34, P43, P44 Second straight portion (an example of “second portion”)
P13, P23 Curved portion
P35, P45 Curved portion (an example of “second portion”)
L1, L2 Test light
PL, PL1, PL2 Plane
W1, W2, W3, W4, W5 Interval

1. An optical waveguide device comprising:
a cladding including a first surface and a second surface different from the first surface;
at least one first core extending through the cladding from the first surface to the second surface; and
a second core formed in a region of the cladding excluding the first core and extending from the first surface through the inside of the cladding to return to the first surface.

2. The optical waveguide device according to claim 1,
wherein the first core includes a core end face exposed on the first surface, and
wherein the second core includes a first core end face and a second core end face exposed on the first surface at positions different from the position of the core end face.

3. The optical waveguide device according to claim 2, wherein the first core end face and the second core end face are disposed in alignment with the core end face in one direction along the first surface.

4. The optical waveguide device according to claim 3, wherein the first core end face and the second core end face are disposed on one side of the core end face in the one direction.

5. The optical waveguide device according to claim 4, wherein the second core extends inside the cladding along a plane intersecting the first surface and passing through the first core end face and the second core end face.

6. The optical waveguide device according to claim 3, wherein the first core end face and the second core end face are respectively disposed on opposite sides of the core end face in the one direction.

7. The optical waveguide device according to claim 6, wherein the second core includes:
a first portion extending along a plane intersecting the first surface and passing through the first core end face and the second core end face; and
a second portion formed in a region spaced from the plane and extending so as to intersect the first core when viewed in the normal direction of the plane.

8. The optical waveguide device according to claim 3, comprising a plurality of first cores,
wherein the core end faces of the plurality of the first cores include:
a first adjacent end face adjacent to either of the first core end face or the second core end face in the one direction; and
a second adjacent end face adjacent to the first adjacent end face in the one direction, and
wherein a distance between the one of the first core end face and the second core end face and the first adjacent end face is the same as a distance between the first adjacent end face and the second adjacent end face.

9. The optical waveguide device according to claim 1, wherein the mode field diameter of the second core on the first surface is the same as the mode field diameter of the first core on the first surface.

10. The optical waveguide device according to claim 1, further comprising a third core formed in a region of the cladding excluding the first core and the second core, and extending from the second surface through the inside of the cladding to return to the second surface.

11. An optical connection structure comprising:
the optical waveguide device according to claim 1; and
an optical fiber array disposed to face the first surface,
wherein the optical fiber array includes:
at least one first optical fiber optically connected to the first core at the first surface; and
a pair of second optical fibers respectively optically connected to both ends of the second core at the first surface.

12. An optical connection method comprising:
preparing the optical waveguide device according to claim 1 a first optical fiber array, and a second optical fiber array;
performing an active alignment between the optical waveguide device and the first optical fiber array so that the first optical fiber array is optically connected to the optical waveguide device in a state in which the first optical fiber array is disposed facing the first surface of the optical waveguide device; and
performing, after the active alignment, an active alignment between the optical waveguide device and the second optical fiber array so that the second optical fiber array is optically connected to the optical waveguide device in a state in which the second optical fiber array is disposed facing the second surface of the optical waveguide device,
wherein, in the performing the active alignment between the optical waveguide device and the first optical fiber array, test light for alignment is emitted from a first alignment optical fiber of the first optical fiber array toward the first surface, the test light traveling from the first surface, passing through the second core, and incident on a second alignment optical fiber of the first optical fiber array is measured, and the arrangement of the optical waveguide device and the first optical fiber array is adjusted so that the intensity of the test light is maximized.

13. An optical waveguide device disposed between a first optical fiber array and a second optical fiber array and configured to optically connect the first optical fiber array and the second optical fiber array, comprising:
a cladding including a first surface facing the first optical fiber array and a second surface facing the second optical fiber array;
at least one communication core extending through the cladding from the first surface to the second surface and capable of transmitting communication light necessary for communication between the first optical fiber array and the second optical fiber array; and
an alignment core formed in a region of the cladding excluding the communication core, extending from the first surface through the inside of the cladding to return to the first surface, and capable of transmitting test light for actively aligning the first optical fiber array and the optical waveguide device.
